(19) United States
(12) Patent Application Publication
(10) Pub. No.: US 2012/0098218 A1
(43) Pub. Date: Apr. 26, 2012

(54) BRAKE PADDLE HAND TRUCK

(76) Inventors: Andrew P. Richard, Gladwin, MI (US); Brian D. Spicer, Bay City, MI (US)

(21) Appl. No.: 12/909,636

(22) Filed: Oct. 21, 2010

(51) Int. Cl. B62B 5/04; B62B 1/00

(52) U.S. Cl. 280/47.24

(57) ABSTRACT

A brake paddle hand truck comprising a hand truck with a frame with a handle at the top and wheels at the bottom, and a braking device comprising an actuator, a brake paddle, and a connector operatively attaching the actuator and brake. The actuator and brake are each pivotally mounted to the side rails of the frame via mounting brackets. The actuator includes a lever to increase the force applied by a user. Preferably two independently rotatable brake paddles, having a lever member and a brake member are provided, and the lever members are connected to the actuator via an upside-down Y-shaped connector. When the actuator is raised, the connector transfers the upward force to brake lever members, which are also raised, causing the brake members to be lowered into contact with the wheels.

### BACKGROUND OF THE INVENTION

The invention relates to the field of hand trucks, and a braking device for hand trucks.

### BRIEF SUMMARY OF THE INVENTION

The invention comprises a hand truck braking device. The braking device comprises a brake actuator which is positioned within reach of the handle of the hand truck, a connector preferably in the form of an upside down Y-shaped cable, and a brake paddle having a lever portion, a pivot and a brake portion. The connector preferably attaches the actuator to each brake element directly, with the tail end of the Y cable attached to the brake actuator and each arm of the Y cable attached to a brake paddle element on one side of the hand truck. The arms connected to the brake paddle elements connect to the lever arm of the brake paddle such that when tension is applied to the cable the paddle break pivots, therefore applying pressure at the brake end of the brake paddle to the wheel.

### BRIEF DESCRIPTION OF THE DRAWINGS

FIG. 1 is a front perspective view of an embodiment of the invention with a U-shaped actuator handle;

FIG. 2 is a rear perspective view of the embodiment shown in FIG. 1;

FIG. 3 is a rear view of the embodiment shown in FIG. 1;

FIG. 4 is a side view of the embodiment shown in FIG. 1;

FIG. 5 is a detailed side view showing the actuator component of the embodiment shown in FIG. 1;

FIG. 6 is a detailed side view showing the brake portion of the embodiment shown in FIG. 1;

FIG. 7 is a front perspective view of an embodiment of the invention with separate handle grips;

FIG. 8 is a rear perspective view of the embodiment shown in FIG. 7;

FIG. 9 is a side view of the embodiment shown in FIG. 7;

FIG. 10 is a detailed side view of the actuator component of the embodiment shown in FIG. 7; and

FIG. 11 is a detailed rear perspective view of an embodiment of the invention with a single pin handle.

### DETAILED DESCRIPTION OF THE PREFERRED EMBODIMENTS

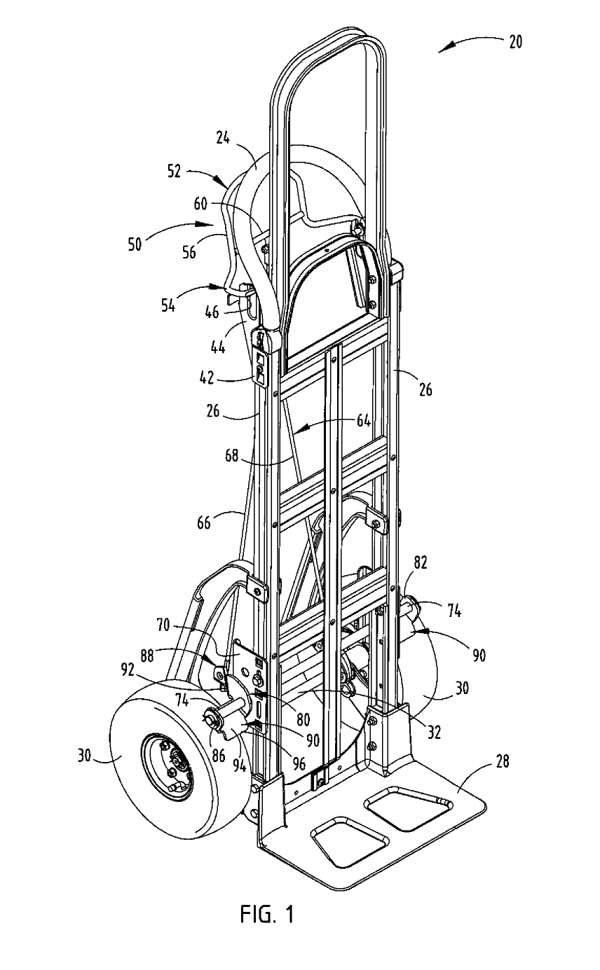

A hand truck 20 according to the preferred embodiment described herein comprises a frame 22, wherein frame 22 comprises a handle 24 for the user, connected on each side to side rails 26 (FIG. 1). Side rails 26 are joined by spaced cross braces, and at the bottom of frame 22, by a nose plate 28. A wheel assembly including a pair of wheels 30 connected via a wheel axle 32, and a braking assembly 40 are mounted on frame 22. The hand truck braking assembly 40 comprises a brake actuator 50, an inverted “Y” connector cable 64, and a brake paddle 80 for each wheel 30.

A brake actuator mounting bracket 42 is affixed to each side rail 26 to attach brake actuator 50 to frame 22. Each brake actuator mounting bracket 42 extends rearwardly from each side rail 26, and includes a hole 46 therethrough for receiving the ends of brake actuator 50. Each brake actuator mounting bracket 42 is preferably formed in a single piece which is mountable on a side rail 26. Brake actuator 50, which is mounted to the hand truck 20 via mounting brackets 42, comprises a brake actuator handle 52, preferably formed of wire rod, bent to define spaced lever portions 54 extending rearwardly from side rails 26, which join with spaced generally vertical portions 56, which in turn join a hand grip 58 which extends between the upper ends of vertical portions 56. Hand grip 58 is located high enough on the frame so that the average user of hand truck 20 does not have to bend to reach hand grip 58. Preferably, hand grip 58 is located within hand's reach for the user of handle 24.

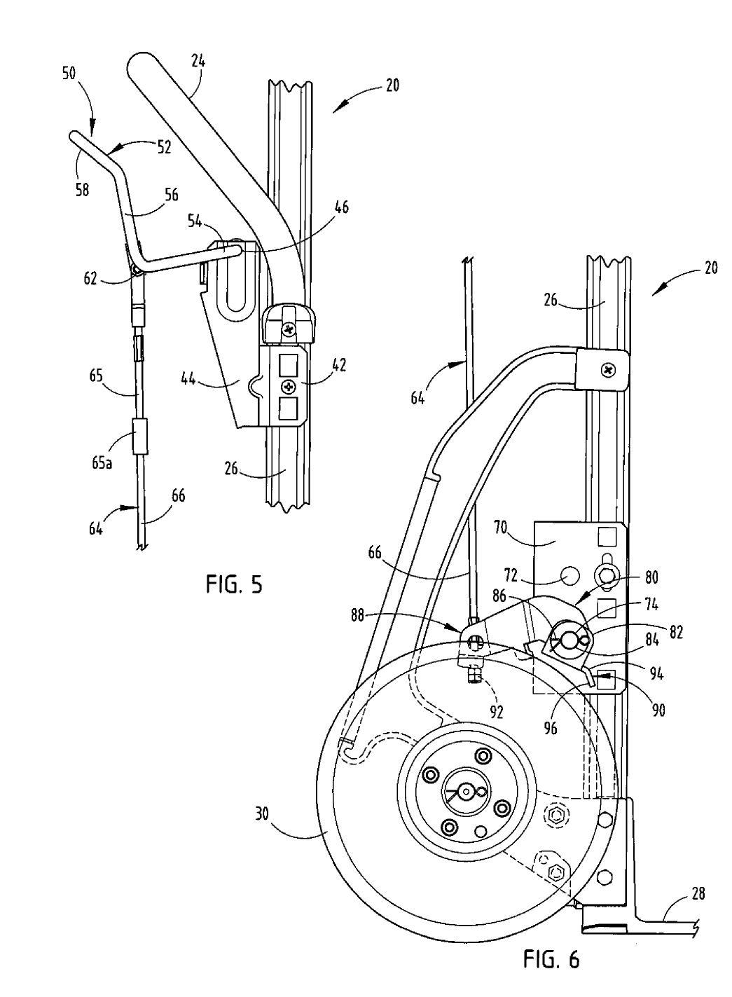

Each brake actuator lever 54 is bent inwardly at its end, such that the inwardly extending ends extend through holes 46 in mounting brackets 42, at about a right angle thereto, thereby pivotally mounting actuator handle 52 to mounting brackets 42 (FIGS. 1 and 5). Each brake actuator lever portion 54 extends generally rearwardly from mounting bracket 42 toward the user, and in a plane which is generally perpendicular to said side rails 26. Vertical portions 56 extend generally upward from the ends of levers 54, until they join the ends of hand grip 58, which is generally parallel to handle 24 (FIG. 1). Lever portions 54 can also be bent inwardly towards one another as they proceed rearwardly from their pivotal mounting to their junction with upwardly extending portions 56, in order to make them less obtrusive to obstacles which might be in the way as the truck is pivoted about a generally vertical axis (FIGS. 1-3).

When we say that lever portions 54 extend rearwardly from side rails 26 in a plane generally perpendicular to side rails 26, we intend to allow form some latitude from 90°, e.g. plus or minus 15°. Lever 54 provides leverage for the operation of braking device 40 when handle 52 is grasped by the user and pulled upwardly toward handle 24.

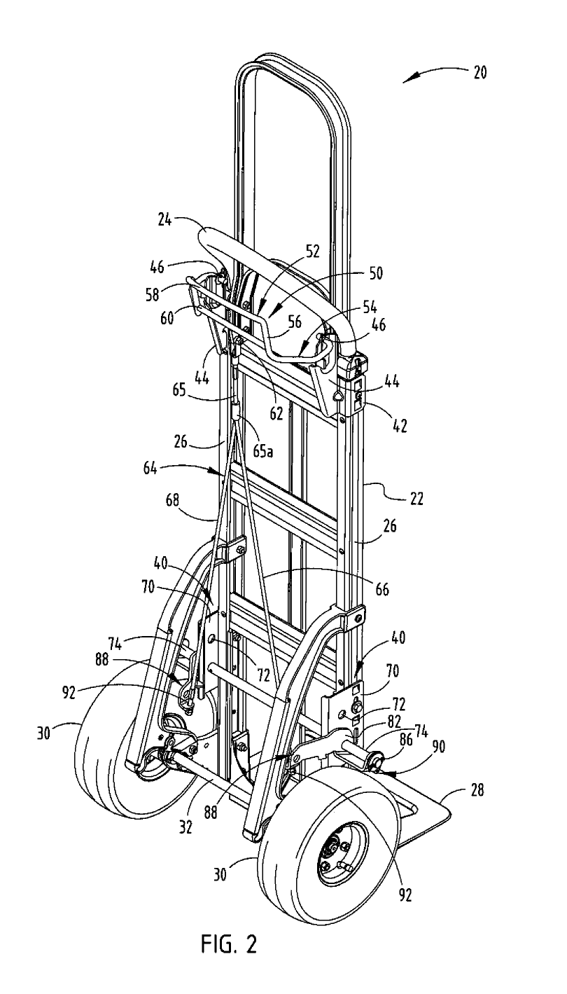

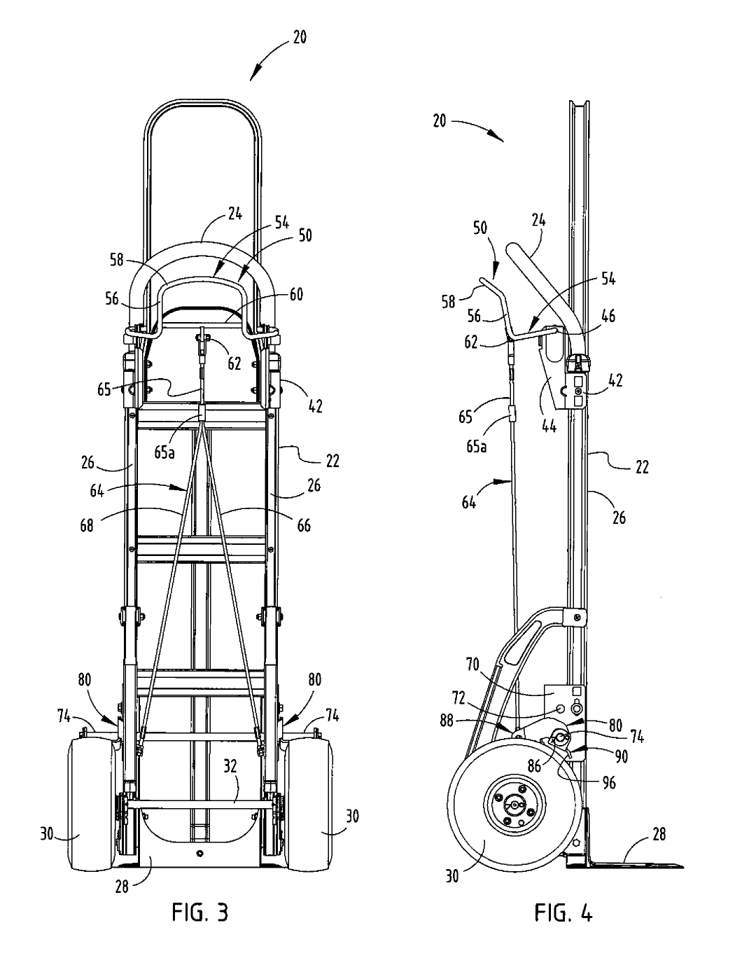

Brake actuator 50 further comprises a cross bar 60 extending between the two sides of the brake actuator handle 52, preferably at a point spaced rearwardly about as far as possible from the side rails 26 in order to maximize leverage. Preferably, it is located at or near the juncture of lever portions 54 and upwardly extending portions 56. Brake actuator crossbar 60 is fitted with an actuator cable mount 62 near the center thereof (FIGS. 1, 3 and 5). Extending from the actuator cable mount 62 is an upside-down Y-shaped cable 64 which includes an upper cable portion 65 which extends downwardly from cable mount 62 for a distance of several inches, which is then coupled by coupling member 65a to a right cable arm 66 and a left cable arm 68, which in turn connect to the brake paddles 80 on each side of hand truck 20 (FIGS. 2 and 3).

On the bottom portion of frame 22, near where wheels 30 are mounted, a brake paddle mounting bracket 70 is provided on each side rail 26 of frame 22, one on the right side rail 26, and one on the left side rail 26. Each brake paddle mounting bracket 70 has a portion extending rearwardly from side rail 26, with a hole 72 therethrough. Brake paddle mounting bracket 70 is preferably a single piece, and may also be formed to be symmetrical, so that one form of bracket 70 can be used on the right side and flipped upside-down to be used on the other side. An axle 74 extends across the back of frame 22 and through hole 72 in each mounting bracket 70, and extends outward beyond the side rails 26, preferably terminating above wheels 30.

One brake paddle 80 is pivotally mounted to each end of axle 74, and the brake paddles 80 are positioned so as to allow each brake paddle 80 to come into contact with a wheel 30 when braking device 40 is actuated by the user (FIG. 6). In a preferred pivotal mounting, each brake paddle 80 has two generally vertical parallel side flanges 82, which each have a broad face which is perpendicular to axle 74. Coaxially aligned holes 84 are provided in each of the side flanges 82, and axle 74 passes therethrough. Brake paddles 80 are preferably freely and independently rotatable about axle 74. Preferably, a pin or fastener 86 is provided at the outer ends of axle 74 to prevent brake paddles 80 from sliding laterally beyond the end of axle 74.

Each brake paddle 80 comprises a lever element 88 on one side of the pivotal mount and a braking element 90 on the other side of the pivotal mount. The legs of the Y-cable 66, 68 are mounted via a brake cable mount 92 to levers 88 of right and left brake paddles 80, respectively. Lever 88 increases the force applied by braking element 90 when braking device 40 is actuated by the user. Lever 88 is preferably integral with and extends rearwardly from the interior side flange 82 (the one located toward the center of frame 22) of the brake paddle 80, to prevent interference with frame 22 (FIG. 2).

Between the side flanges 82 of brake paddle 80, a wide paddle member 94 is generally oriented so as to be tangential to the outer surface of wheel 30. (FIG. 6). The paddle member 94 serves to add stability and rigidity to brake paddle 80. A braking member 96 extends forward from paddle member 94 in a direction opposite lever 88, and is angled downward toward the surface of wheel 30. The dimensions of and angle between the paddle portions 94 and 96 are such that the leading edge of braking member 96 engages wheel 30, to create the braking force when brake paddle 80 is actuated by brake actuator 50. Also, it is preferable that braking paddle portions 94 and 96 be oriented over the forwardly facing portions of wheels 30.

When brake actuator handle 52 is lifted by the operator to come into closer contact with handle 24, brake actuator crossbar 60 is also raised, which pulls Y cable 64 in an upward direction, transferring the force to the right and left legs 66, 68 of Y cable 64. The motion of right and left legs of Y cable 66, 68 lifts lever element 88 of brake paddle 80. The pivotal mounting of brake paddle 80 means that each braking element 90 of brake paddle 80 is rotated downwardly so that braking surface 96 is brought into contact with wheels 30 when lever 88 is lifted by an upward force on Y-cable 64. Due to the use of a Y-shaped cable 64 having a short upper cable length 65 coupled to right leg 66 and left leg 68, and due to the individually pivotal brake paddles 80, brake paddles 80 are permitted to apply force evenly to wheels 30 even if there is some unevenness of wear or inflation or other potential inconsistency between each of the wheels 30. This self equalization of brake force is achieved because the flexible upper cable 65 is free to swing right or left slightly, allowing the cable coupling member 65a to shift left or right in response to what would otherwise be unequal tension on cable legs 66 and 68. It is important that upper cable portion 65 be of sufficient length to allow this side to side brake force equalizing swinging motion.

Location and placement of the brake actuator handle 52 permits the operator of hand truck 20 to easily brake or apply light pressure to the brakes to slow moving hand truck 20 or to lock hand truck 20 into position.

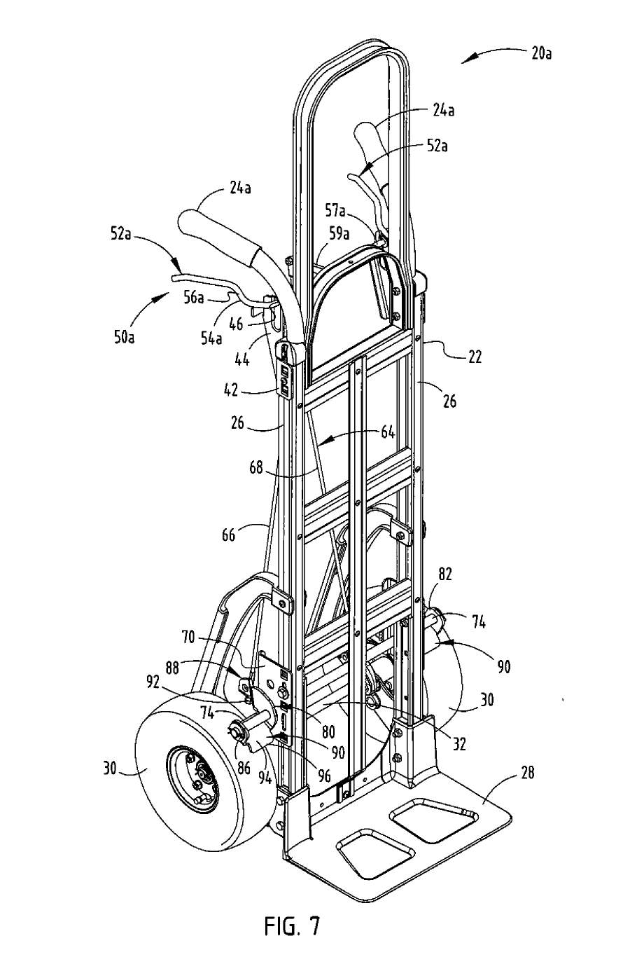

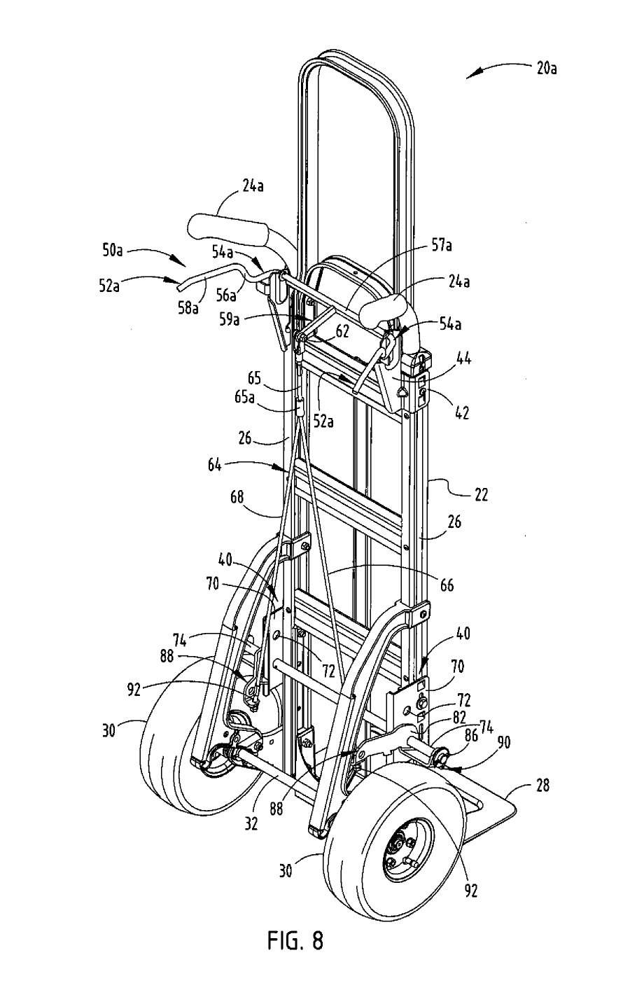

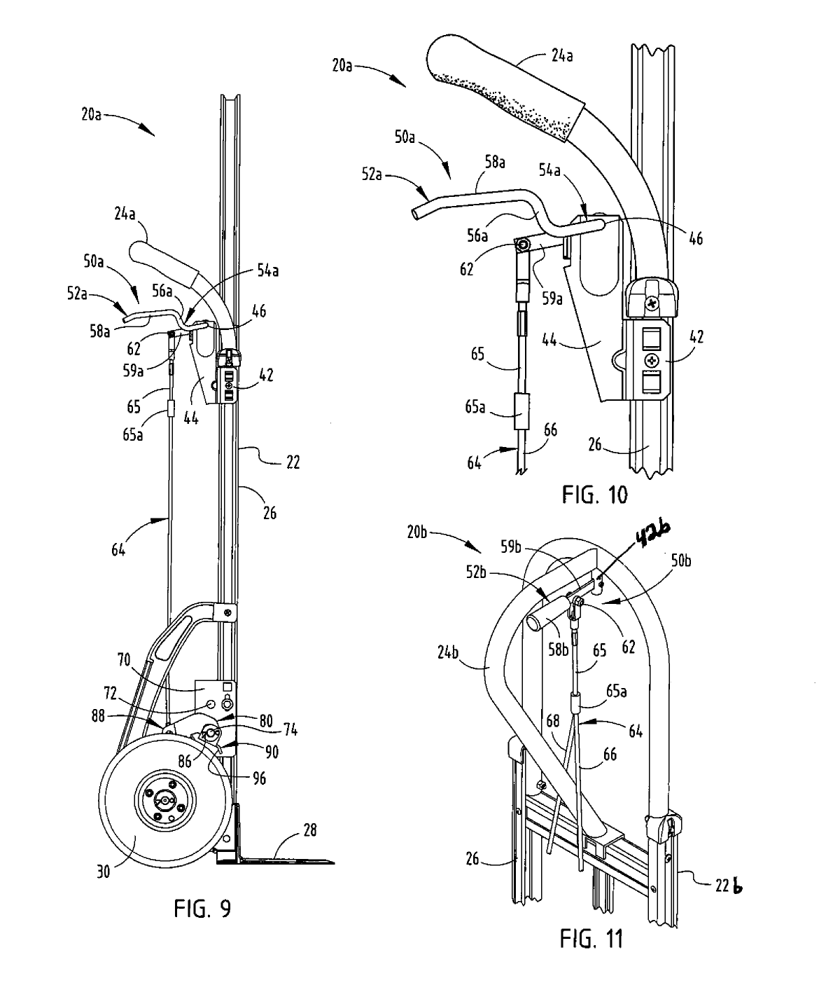

FIGS. 7-10 disclose an alternative embodiment hand truck 20a which employs separate rearwardly extending left and right handles 24a, rather than a single handle 24 as in truck 20. Brake actuator handle 52a in turn, is formed in reverse from actuator handle 52, such that the inner ends of portions 54a are joined to a pivot rod 57 extending across the back of frame 22 between the brake actuator mounts 44 (FIG. 8). A lever arm 59a is joined to and projects laterally and rearwardly from pivot rod 57a, generally perpendicular to frame 22. Cable coupling 62 is then secured to the end of lever arm 59a and serves to connect cable portion 65 to lever arm 59a.

The hand grip portions 58a of brake actuator handle 52a extend rearwardly from the upwardly extending portions 56a, and thus are an extension of portions 54a. In this embodiment, the leverage applied by squeezing hand grip portions 58a upwardly towards handles 24a is converted to pivotal motion, which is conveyed to brake cable 64 through lever arm 59a. Lever arm 59a is the “lever” portion of the actuator handle 52a of this embodiment, which acts directly through brake cable 64 on brake paddles 80. As with the first embodiment hand truck 20, location and placement of the brake actuator handle 52a permits the operator of hand truck 20a to easily brake or apply light pressure to the brakes to slow moving hand truck 20a or to lock hand truck 20a into position.

FIG. 11 discloses another alternative embodiment hand truck 20b which employs a rounded upper portion of frame 22b, with handle 24b extending backward from the top of frame 22b and then looping toward a brace in frame 22b. A brake actuator mount 42b extends downwardly from the top of frame 22b, with lever arm 59b pivotally attached to the end thereof, and extending rearwardly below handle 24b. Handle 58b extends from the free end of lever 59b. Cable coupling 62 is secured to lever arm 59b and serves to connect cable portion 65 to lever arm 59b.

In this embodiment, the leverage applied by squeezing hand grip 58b upwardly toward handle 24b is converted to pivotal motion, which is conveyed to brake cable 64 through pivot lever arm 59b. Lever arm 59b is the “lever” portion of the actuator handle 52b of this embodiment, which acts directly through brake cable 64 on brake paddles 80. As with the first and second embodiments of hand trucks 20, 20a, location and placement of the brake actuator handle 52b permits the operator of hand truck 52b to easily brake or apply light pressure to the brakes to slow moving hand truck 20b or lock hand truck 20b into position.

Of course it is understood that the above is a description of preferred embodiments, and that various changes and alterations can be made to the hand truck 20 and braking device 40 without departing from the spirit and broader aspects of the invention.

What is claimed is:

1. A brake paddle hand truck, comprising:
a hand tuck, having a frame, at least one handle near the top thereof, and a pair of wheels rotatably mounted near the bottom thereof; and
a braking device comprising a brake actuator pivotally attached to said frame near the hand truck handle, said actuator comprising at least one hand grip and an actuator lever which extends generally rearwardly away from said frame;
at least one brake paddle, comprising a lever member and a braking member, which is pivotally attached to said frame at a position along the length of the brake paddle between the lever member and the braking member, such that the braking member is positioned adjacent to the wheel; and
a connector, which attaches at one of its ends to said actuator lever of said brake actuator, and at another of its ends to the lever element of the brake paddle, and which is capable of transferring forces applied to the actuator to the lever member of the brake paddle.

2. The brake paddle hand truck of claim 1, having two brake paddles.

3. The brake paddle hand truck of claim 2, wherein brake paddles are independently rotatable.

4. The brake paddle hand truck of claim 3, wherein the connector is in the shape of an upside-down Y, comprising an upper portion connected to said actuator lever at its top and to a pair of downwardly extending legs at its bottom, with each leg of the “Y” attached to one brake paddle; said connector upper portion being free to swing to the left or right relative to said actuator lever, whereby the braking forces acting on said wheels are self equalizing.

5. The brake paddle hand truck of claim 4, wherein said actuator comprises a wire rod bent to define an actuator lever portion at each end thereof, pivotally mounted to said frame and extending rearwardly therefrom in a generally horizontal plane, an upwardly extending portion extending upwardly from each of said lever portions, and a hand grip portion extending between the upper ends of said upwardly extending portions; said actuator further comprising a cross member extending between the sides of said actuator defined by said lever and upwardly extending portions, and being connected thereto near the juncture between said lever and upwardly extending portions; said connector being connected to said cross member.

6. The brake paddle hand truck of claim 5, further comprising a first actuator mounting bracket attached to a first side of said frame and a second actuator mounting bracket attached to a second side of said frame, each said actuator mounting bracket having a hole therein; said lever portions of said actuator being bent inwardly at their ends, said inwardly bent portions extending through said mounting bracket holes whereby said actuator is pivotally mounted to the first and second actuator mounting brackets.

7. The brake paddle hand truck of claim 4, wherein said actuator comprises two actuator hand grips connected to and extending rearwardly from a pivot rod; said pivot rod being rotatably mounted to, and extending generally across the rear of, said frame; said actuator lever being connected to and extending rearwardly from said pivot rod and from said frame.

8. The brake paddle hand truck of claim 7 wherein said actuator comprises a wire rod bent to define said hand grips and said pivot rod.

9. The brake paddle hand truck of claim 4, wherein the actuator comprises the actuator lever extending rearwardly from and pivotally attached to an actuator mount attached near the top of the frame, with the actuator handle attached to and extending from the free end of the actuator lever.

10. The brake paddle hand truck of claim 4 wherein each said brake paddle is mounted so as to engage the front upper portion of said wheel when said actuator is pivoted.

11. The brake paddle hand truck of claim 10 wherein each said brake paddle comprises first and second braking portions formed at an angle to one another such that the leading edge of said second portion engages said wheel when the actuator is pivoted.

12. The brake paddle hand truck of claim 11 in which said brake paddle is formed in a single piece.

13. The brake paddle hand truck of claim 12, further comprising a brake mounting bracket attached to said frame generally adjacent each said wheel, wherein each said brake paddle is pivotally mounted to one of said brake mounting brackets.

14. The brake paddle hand truck of claim 13, further comprising an axle which extends across the width of the hand truck and through a hole provided in each brake mounting bracket, and which extends laterally beyond the mounting bracket, wherein the brake paddles are pivotally attached to the axle at a width greater than that of said frames.

15. The brake paddle hand truck of claim 1, wherein said actuator comprises a wire rod bent to define an actuator lever portion at each end thereof, pivotally mounted to said frame and extending rearwardly therefrom in a generally horizontal plane, an upwardly extending portion extending upwardly from each of said lever portions, and a hand grip portion extending between the upper ends of said upwardly extending portions; said actuator further comprising a cross member extending between the sides of said actuator defined by said lever and upwardly extending portions, and being connected thereto near the juncture between said lever and upwardly extending portions; said connector being connected to said cross member.

16. The brake paddle hand truck of claim 15, further comprising a first actuator mounting bracket attached to a first side of said frame and a second actuator mounting bracket attached to a second side of said frame, each said actuator mounting bracket having a hole therein; said lever portions of said actuator being bent inwardly at their ends, said inwardly bent portions extending through said mounting bracket holes whereby said actuator is pivotally mounted to the first and second actuator mounting brackets.

17. The brake paddle hand truck of claim 1, wherein said actuator comprises two actuator hand grips connected to and extending rearwardly from a pivot rod; said pivot rod being rotatably mounted to, and extending generally across the rear of, said frame; said actuator lever being connected to and extending rearwardly from said pivot rod and from said frame.

18. The brake paddle hand truck of claim 17 wherein said actuator comprises a wire rod bent to define said hand grips and said pivot rod.

19. The brake paddle hand truck of claim 1, wherein the actuator comprises the actuator lever extending rearwardly from and pivotally attached to an actuator mount attached near the top of the frame, with an actuator handle attached to and extending from the free end of the actuator lever.

20. The brake paddle hand truck of claim 1 wherein each said brake paddle is mounted so as to engage the front upper portion of said wheel when said actuator is pivoted.

21. The brake paddle hand truck of claim 20 wherein each said brake paddle comprises first and second braking portions formed at an angle to one another such that the leading edge of said second portion engages said wheel when the actuator is pivoted.

22. The brake paddle hand truck of claim 21 in which said brake paddle is formed in a single piece.

23. The brake paddle hand truck of claim 22, further comprising a brake mounting bracket attached to said frame generally adjacent each said wheel, wherein each said brake paddle is pivotally mounted to one of said brake mounting brackets.

24. The brake paddle hand truck of claim 23, further comprising an axle which extends across the width of the hand truck and through a hole provided in each brake mounting bracket, and which extends laterally beyond the mounting bracket, wherein the brake paddles are pivotally attached to the axle at a width greater than that of said frames.

25. The brake paddle hand truck of claim 1, wherein the brake paddle is formed in a single piece.

26. A braking device as described in claim 1 adapted for attachment to an existing hand truck.

27. A brake paddle hand truck, comprising:
a hand tuck, having a frame with side rails, at least one handle near the top thereof, and a pair of wheels rotatably mounted near the bottom thereof; and
a braking device comprising a brake actuator, comprising at least one hand grip which is pivotally attached to said frame near the hand truck handle; at least one brake paddle, comprising a lever member and a braking member, which is pivotally attached to said frame at a position along the length of the brake paddle between the lever member and the braking member, such that the braking member is positioned adjacent to the wheel; and a connector, which attaches at one of its ends to the brake actuator, and at another of its ends to the lever element of the brake paddle, and which is capable of transferring forces applied to the actuator to the lever member of the brake paddle.
